(19) United States
(12) Patent Application Publication
(10) Pub. No.: US 2013/0163759 A1
(43) Pub. Date: Jun. 27, 2013

(54) QUANTUM KEY DISTRIBUTION METHOD AND APPARATUS

(71) Applicants: Keith Harrison, Chepstow (GB); William Munro, Bristol (GB)

(72) Inventors: Keith Harrison, Chepstow (GB); William Munro, Bristol (GB)

(21) Appl. No.: 13/575,201

(22) PCT Filed: Jan. 28, 2011
(86) PCT No.: PCT/US11/22934

§ 371 Date: Jul. 25, 2012

(30) Foreign Application Priority Data
Jan. 29, 2010 (GB) 1001422.3

(51) Int. Cl. H04L 9/08

(52) U.S. Cl. CPC H04L 9/0883
USPC 380/268

(57) ABSTRACT

A QKD transmission method comprises generating a transmission list for a plurality of data bits, the list comprising a randomized timing schedule defining respective times for transmission of the data bits, providing a clock signal and using the clock signal to initiate the transmission of the data bits at a predetermined time in order to provide a QKD signal, and an apparatus therefor.

### BACKGROUND

Quantum key distribution (QKD) methods and systems have been developed which enable two parties to share random data in a way that has a very high probability of detecting any eavesdroppers. This means that if no eavesdroppers are detected, the parties can have a high degree of confidence that the shared random data is secret. QKD methods and systems are described, for example, in U.S. Pat. No. 5,515,438, U.S. Pat. No. 5,999,285 and GB 2427317 A.

Whatever particular QKD system is used, QKD methods typically involve QKD transmitting apparatus 10 (see FIG. 1 of the accompanying drawings) using a QKD transmitter 12 to send a random data set provided by random source 11, over a quantum signal channel 5 to a QKD receiver 22 of QKD receiving apparatus 20. The QKD transmitting and receiving apparatus 10, 20 then respectively process the data transmitted and received via the quantum signal channel in respective processing sub-systems 13, 23 thereby to derive a common subset m of the random data set. This processing is done with the aid of messages exchanged between the processing sub-systems 13, 23 via an insecure classical communication channel 6 established between classical channel transceivers 14 and 24 of the transmitting and receiving apparatus 10, 20 respectively. As the quantum signal channel 5 is a noisy channel, the processing of the data received over that channel includes an error correction phase that relies on messages exchanged over the classical channel 6.

In some QKD systems, the quantum signal is embodied as a stream of randomly polarized photons sent from the transmitting apparatus to the receiving apparatus either through a fiber-optic cable or free space; such systems typically operate according to the BB84 quantum coding scheme (see for example C. H. Bennett and G. Brassard “Quantum Cryptography: Public Key Distribution and Coin Tossing”, Proceedings of IEEE International Conference on Computers Systems and Signal Processing, Bangalore, India, December 1984, pp 175-179).

In such systems, the QKD transmitter 12 provides the optical components for selectively polarizing photons, and the QKD receiver 22 provides the optical components for receiving photons and detecting their polarization. Typically, these optical components establish two pairs of orthogonal polarization axes, the two pairs of polarization axes being offset by 45° relative to each other. Conventionally, these two pairs of polarization axes are referred to as vertical/horizontal and diagonal/anti-diagonal respectively. An example QKD transmitter 12 and QKD receiver 22 will now be described with reference to FIGS. 2 and 3 respectively of the accompanying drawings.

The QKD transmitter 12 of FIG. 2 comprises an array of light emitting diodes (LEDs) 15A-D in front of each of which is a respective polarizing filter 16A-16D. Filter 16A polarizes photons emitted from LED 15A vertically, filter 16B polarizes photons emitted from LED 15B horizontally, filter 16C polarizes photons emitted from LED 16C diagonally and filter 16D polarizes photons emitted from LED 16D anti-diagonally. Thus, each photon in the stream of photons coming away from the filters 16A-D, is polarized in one of four directions, these directions corresponding to two pairs of orthogonal polarization axes at 45° to each other. A fibre optic light guide 17 conveys the polarized photons out through a lens via a narrow band pass frequency filter 18 (for restricting the emitted photons to a narrow frequency range, typically plus or minus 1nm), and a spatial filter 19 (for restricting the emitted photons to a narrow frequency range and for obfuscating the characteristics of the particular LED that fired). An attenuation arrangement, not specifically illustrated, is also provided is to reduce the number of photons emitted; the attenuation arrangement may simply be an attenuating filter placed near the other filters or may take the form of individual power control circuits for regulating the power fed to each LED 15A to 15D when pulsed. Without the attenuation arrangement the number of photons emitted each time a LED is pulsed at normal levels would, for example, be of the order of one million; with the attenuation arrangement in place, the average emission rate is 1 photon per 10 pulses. Importantly this means that more than one photon is rarely emitted per pulse.

The FIG. 3 QKD receiver 22 comprises a lens 25, a quad-detector arrangement 30, and a fibre optic light guide 26 for conveying photons received through the lens 25 to the quad-detector arrangement 30. The quad-detector arrangement 30 comprises a beam splitter 31, a half-wave plate 36 for rotating the polarization of photons by 45°, a first paired-detector unit 32, and a second paired-detector unit 33. The first paired-detector unit 32 comprises a polarization-dependent beam splitter 34 and detectors 37A, 37B; the presence of the beam splitter 34 causes the polarizations detected by the detectors 37A and 37B to be mutually orthogonal. The second paired-detector unit 33 comprises a polarization-dependent beam splitter 35 and detectors 37C, 37D; the presence of the beam splitter 35 causes the polarizations detected by the detectors 37C and 37D to be mutually orthogonal. The polarization rotation effected by half-wave plate 36 causes the polarizations detected by the detectors 37A, 37B to be at 45° to those detected by the detectors 37C, 37D; more specifically, the paired detector unit 33 is arranged to detect horizontal/vertical polarizations whereas the paired detector unit 33 is arranged to detect diagonal/anti-diagonal polarizations.

The beam splitter 31 is depicted in FIG. 3 as half-silvered mirror but can be of other forms such as diffraction gratings. The polarization-dependent beam splitters 34, 35 are, for example, birefringent beam splitters.

Operation of the apparatus of FIGS. 1 to 3 in accordance with the BB84 protocol is generally as follows with the QKD transmitting apparatus 10 and QKD receiving apparatus 20 being conventionally referred to as ‘Alice’ and ‘Bob’ respectively.

Alice randomly generates (using source 11) a multiplicity of pairs of bits, typically of the order of 10⁸ pairs. Each pair of bits consists of a data bit and a basis bit, the latter indicating the pair of polarization axes to be used for sending the data bit, be it vertical/horizontal or diagonal/anti-diagonal. A horizontally or diagonally polarized photon indicates a binary 1, while a vertically or anti-diagonally polarized photon indicates a binary 0. The data bit of each pair is thus sent by Alice over the quantum signal channel 5 encoded according to the pair of polarization directions indicated by the basis bit of the same pair. When receiving the quantum signal from Alice, Bob randomly chooses, by virtue of the action of the half-silvered mirror 31, which paired-detector unit 32, 33 and thus which basis (pair of polarization directions) it will use to detect the quantum signal during each time slot and records the results. The sending of the data bits of the randomly-generated pairs of bits is the only communication that need occur using the quantum channel 5.

Next, Bob sends Alice, via the classical channel 6, partial reception data comprising the time slots in which a signal was received, and the basis (i.e. pair of polarization directions) thereof, but not the data bit values determined as received.

Alice then determines a subset m of its transmitted data as the data bit values transmitted for the time slots for which Bob received the quantum signal and used the correct basis for determining the received bit value. Alice also sends Bob, via the classical channel 6, information identifying the time slots holding the data bit values of m. Bob then determines the data bit values making up the received data. The next phase of operation is error correction of the received data by an error correction process involving messages passed over the classical channel 6; after error correction, Bob's received data should match the data m held by Alice and this can be confirmed by exchanging checksums over the classical channel 6.

Accordingly, the QKD system transmits information by the use of polarized photons or by phase encoding photons. Alice creates a stream of encoded photons and Bob has to detect them. It has become traditional for these photons to be emitted at a fixed time interval. For example every 100 ns, a photon is emitted by Alice. Bob knows this fact and can therefore make measurements at the appropriate time. However, a potential eavesdropper may also know the repetition rate, in which case they can also take measurements which compromise the security of the system.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a diagram of a known QKD system;

FIG. 2 is a diagram of a QKD transmitter of the FIG. 1 system;

FIG. 3 is a diagram of a QKD receiver of the FIG. 1 system;

FIG. 4 is a schematic representation of a QKD system according to an embodiment;

FIG. 5a is a schematic representation of an timing schedule for a transmitter according to an embodiment;

FIG. 5b is a table depicting an exemplary transmission timing schedule according to an embodiment;

FIG. 5c is a table depicting an exemplary transmission timing schedule according to an embodiment;

FIG. 6 is a schematic representation of a timing schedule for a receiver according to an embodiment; and

FIG. 7 is a flow chart depicting a handshake protocol according to an embodiment.

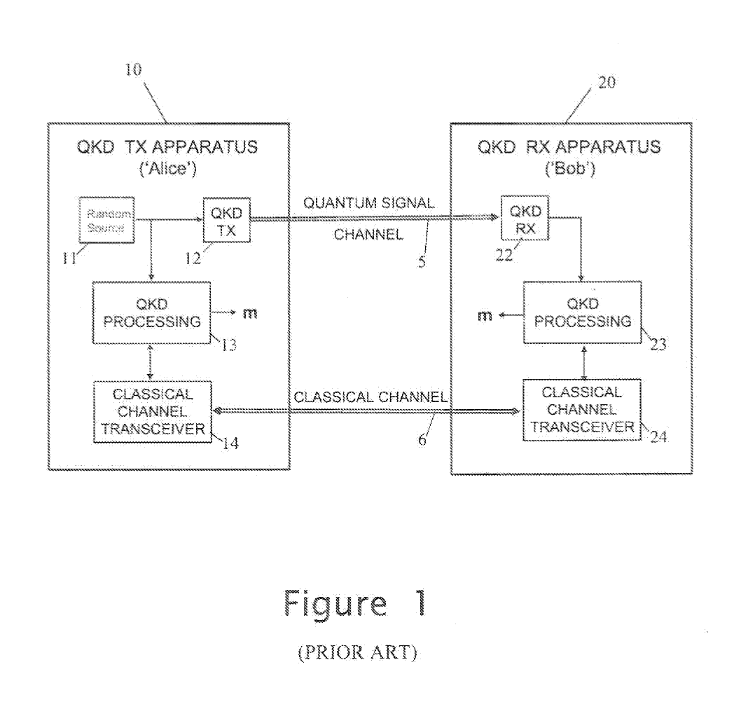

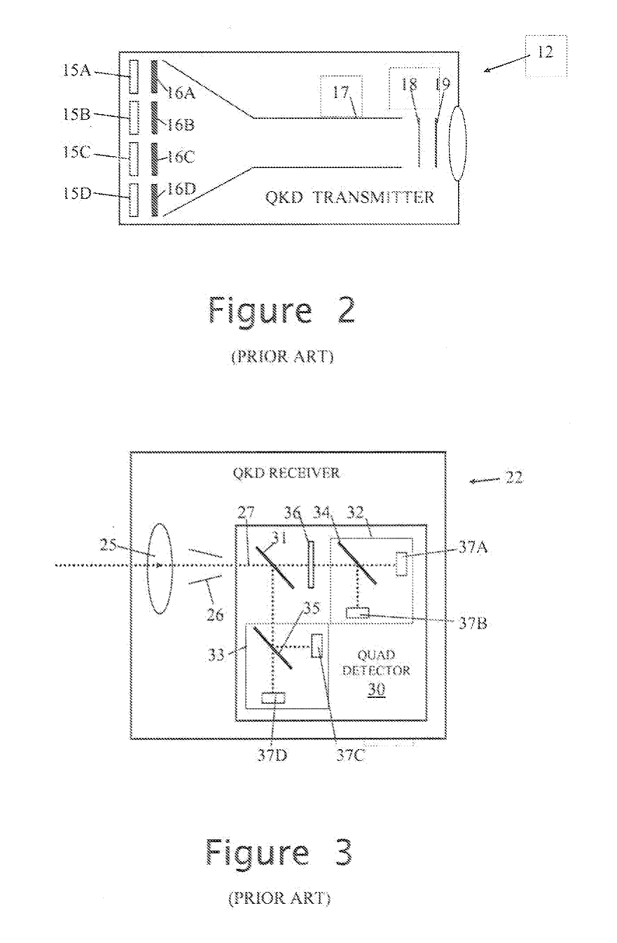

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first item could be termed a second item, and, similarly, a second item could be termed a first item, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

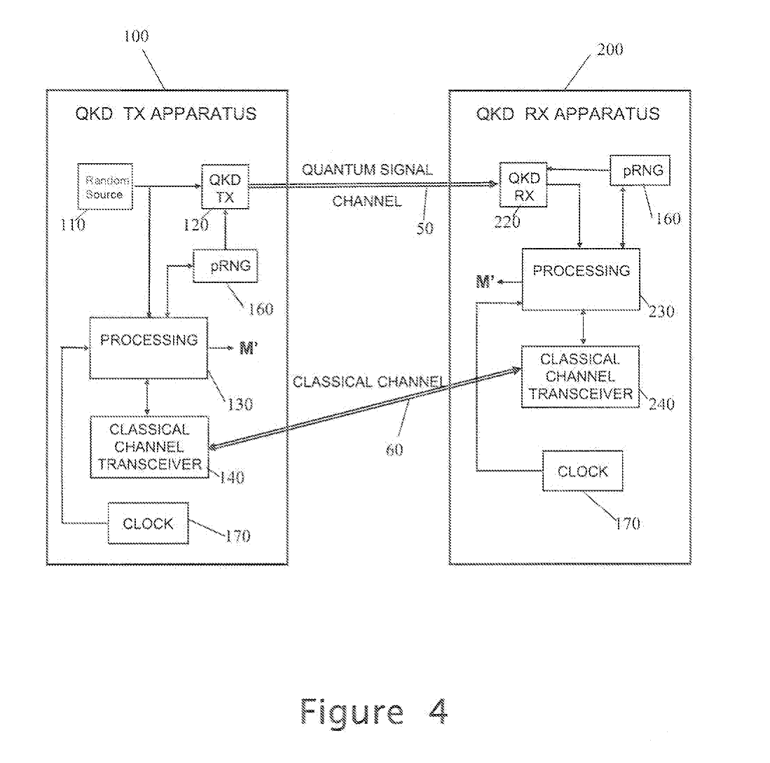

FIG. 4 is a schematic representation of a QKD system according to an embodiment. Both QKD transmitting apparatus 100 and QKD receiving apparatus 200 include a pseudo random number generator (pRNG). The pRNG 160 at both the transmitter and receiver ends of the system of FIG. 4 are the same type of pRNG, such that, when both pRNGs are primed with the same seed, they generate an identical set of random numbers over time. That is to say, priming each pRNG 160 with the same seed gives both the QKD transmitter 120 and receiver 220 access to the same sequence of random numbers. According to an embodiment, the pRNGs are crypto-quality generators. That is to say, it should not be possible to predict future values given previous values produced by one of the pRNGs 160. An example of a suitable pRNG that can be used is a Mersenne twister such as that described in “Mersenne twister: a 623-dimensionally equidistributed uniform pseudo-random number generator, Makoto Matsumoto, Takuji Nishimura, ACM Transactions on Modeling and Computer Simulation (TOMACS), Volume 8, Issue 1 (January 1998), Pages: 3-30, ACM, New York, USA”, the contents of which are incorporated herein by reference in their entirety.

Transmitter 120 can use a randomly generated number sequence from generator 160 in order to effect transmission of data bits at random times, i.e. the period of a data signal from transmitter 120 will be irregular. Providing the pRNG is of sufficient quality (as described above), the period cannot be determined by an eavesdropper within a time frame before the seeds are changed by the system. According to an embodiment, an initial seed used to bootstrap the system can be agreed upon in a secure environment for example. The seeds can then be changed periodically as required, such as after each session for example, or after a predetermined number of random numbers have been generated by a pRNG. A new seed can be a number of bits from the shared secret from a previous session generated using the system according to an embodiment. For example, a seed can comprise the first 256 bits of a shared secret. This has the advantage that no information needs to be sent between sub-system because both Alice and Bob have the same secret data, and can therefore simply use the agreed number of bits as a new seed. Further, it will be appreciated that this process cannot be influenced by Alice or Bob.

Alternatively, a seed can be chosen by Alice and sent to Bob. There are several ways this can be achieved. For example, the chosen seed can be xor'ed with a one-time pad secret taken from the shared secret data generated in the previous session. The result is transmitted to Bob who can xor this data with the same on-time pad secret to reveal the seed chosen by Alice. This uses the same amount of data from the shared secret as the seed (such as 256 bits for example). Alternatively, a seed chosen by Alice can be encrypted using an encryption scheme such as AES for example, which scheme uses data from the shared secret to perform the encryption. The corresponding encrypted seed can be decrypted by Bob using the same one-time pad data to reveal the chosen seed for a session. It will be appreciated that AES encryption can use from 128 to 256 bits of data for encryption, and that this scheme can therefore use less of the shared secret than the previous methods (but is less secure as a result). Other alternatives for providing a shared seed are possible as will be appreciated by those skilled in the art.

Therefore, according to an embodiment, transmission times for data bits are varied randomly by using a randomly generated number sequence to provide a list of times for transmission of the bits from transmitter 120 (transmission list). For example, generator 160 can provide a random number between 0 and 1 inclusive. A function can be defined to provide a set of time values which are added to a base time to provide the timings for a transmission list. According to an embodiment, such a function can take the form ar+b where r is the random number generated by the generator 160, and the parameters a and b are time parameters which are set to desired values before a session, are fixed for all sessions for a given apparatus, or can be changed at will. For example, for a=997 ns, and b=3 ns a minimum time value is 3 ns, and a maximum is 1000 ns depending on the value of r which is generated. Alternatively, a Gaussian distribution for a time value can be used, such that a time value is proportional to exp(−x²r) for example. It will be appreciated by those skilled in the art that other alternatives are possible, and the above is not intended to be limiting. In any case, the particular values for parameters of the function chosen should be selected to preclude the possibility that two data bits are transmitted within a period of time which is the same as or smaller than a minimum detection period for one data bit at receiver 220. That is to say, the parameters should be chosen taking into account the ability of the receiver to resolve data bits, and so the minimum value obtained must be chosen accordingly.

Accordingly, instead of transmitter 120 transmitting a data bit at regular intervals (such as every 100 ns for example), data bits are transmitted at irregular intervals. Due to the tolerance in the physical components that go to make up the transmission apparatus, and the fact that—on average—only 1 in 10 photons produced by apparatus 100 will emerge from transmitter 120, there will be a degree of latitude associated with the exact time at which a data bit is transmitted. It is, in general, not possible to specify precisely when a data bit will be transmitted by transmitter 120, only that, at the predetermined time as defined above, a data bit should be transmitted within a notional window. Generally speaking, this is due to the fact (amongst other things) that it is not possible to specify exactly when a photon will emerge from transmission apparatus 100 due to the emission characteristics of the LEDs. Accordingly, there are respective time windows for transmission, the duration of which are defined by the working and manufacturing tolerances of the equipment. The time windows will, in general, be centred on the time for transmission that has been set by the transmitter 120. That is to say, at time t, and for a transmission of a data bit u, it is possible that u will be transmitted at any point within t−d/2 to t+d/2, where d is a time factor which depends on the tolerances associated with the components from which the transmitter 120 and other elements of apparatus 100 are composed. In general, d should be no more than 2 ns.

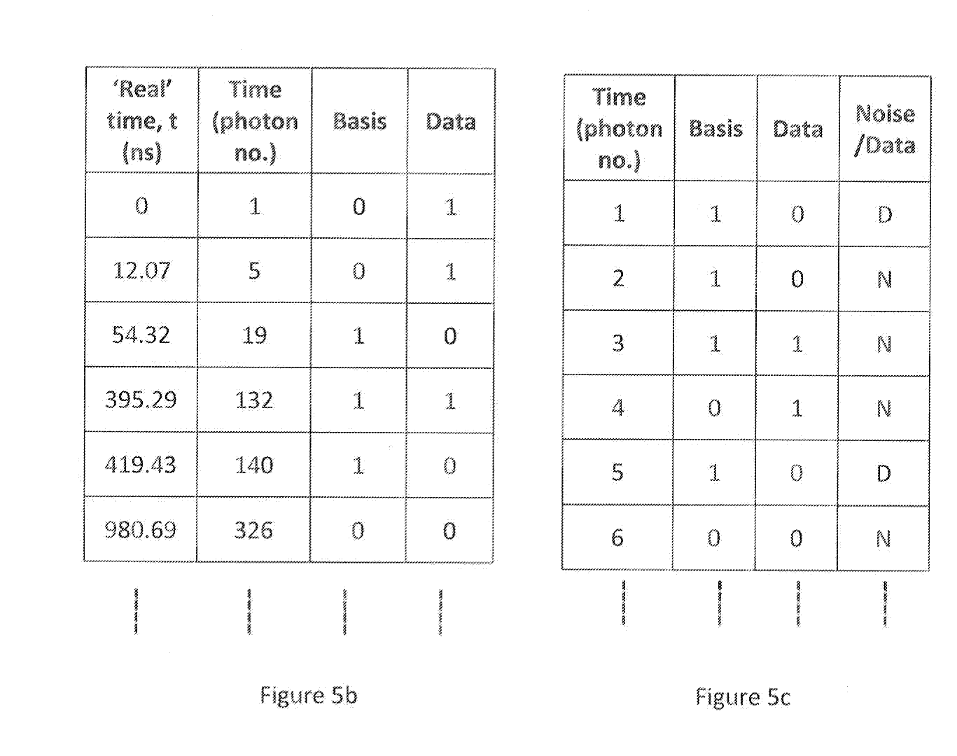

FIG. 5a is a schematic representation of an exemplary timing schedule for transmitter 120 according to an embodiment. Dotted line 500 represents a base time for the system, i.e. t=0, which is the time from which transmission timings can be measured. Solid lines 510 represent the relative time at which a data bit is transmitted by the system. Given a function used to define a time for transmission from t=0 as described above, it can be seen that the time for transmissions 1 through 9 occur at random intervals, thus having the effect that the period of the data signal sent by transmitter 120 is irregular. The irregular nature effectively masks the fact that a bona fide QKD system is being used (since all current QKD systems operate according to a regular period for transmission in the quantum channel). So, for example, transmission 1 occurs 20 ns after t=0. Transmission 2 occurs 30 ns later, i.e. 50 ns after t=0, and transmission 3 occurs 60 ns after transmission 2, or 110 ns after t=0.

According to an embodiment, not all data bits sent by transmitter 120 need be a valid part of a data signal. That is to say, the data bits sent by transmitter 120 can comprise actual data values as well as spurious ones, i.e. noise, both in the form of polarised photons for example. Irrespective of the nature of transmitted photons, each one (data or noise) can be sent according to a random timing schedule. This further decreases the likelihood of successful interception of a valid data signal by an eavesdropper since (if they are able to intercept a photon, perhaps because two were transmitted instead of one) they will not know whether the photon constitutes a valid data bit or random noise—the two will be indistinguishable from their point of view, and only Alice is aware which are which at his stage. Alternatively, data bits and noise can be sent regularly, but the relative disposition of data bits within the noise can be random such that there is no discernable pattern to a data signal which would enable an eavesdropper to differentiate between data and noise bits.

FIG. 5b is a table depicting an exemplary transmission timing schedule according to an embodiment for a set of basis and data values to be encoded according to the description above. Each integer in the time column translates to a ‘real’ time for transmission of a polarised photon, the basis and data and value of which are chosen according to the description above. As can be seen, transmission timings are random. No transmissions need take place in between the times shown. Alternatively, transmission of spurious data bits (i.e. noise) can be transmitted in between the times of bona fide data bits. The timings of the spurious data bits can also vary randomly, but an eavesdropper will not be able to differentiate one from the other.

FIG. 5c is a table depicting an exemplary transmission timing schedule according to an embodiment for a set of basis and data values to be encoded according to the description above, including the provision of noise data. In this scheme however, data and noise bits are sent at regular intervals in the timing schedule. However, the disposition of useful data bits within such a signal is random, therefore giving an irregular data signal. As can be seen, in the regular time slots where data bits are not transmitted, noise bits can be transmitted.

As explained, since there will be a tolerance associated with precisely when a data bit is transmitted, according to an embodiment the receiver causes a detector to switch on for a time period of duration d centred at time t in order to ensure that a data bit is measured. The exact value of d will vary taking into account the nature of the system and components involved, but typically, a window of 2 ns will be sufficient. Other alternatives are of course possible.

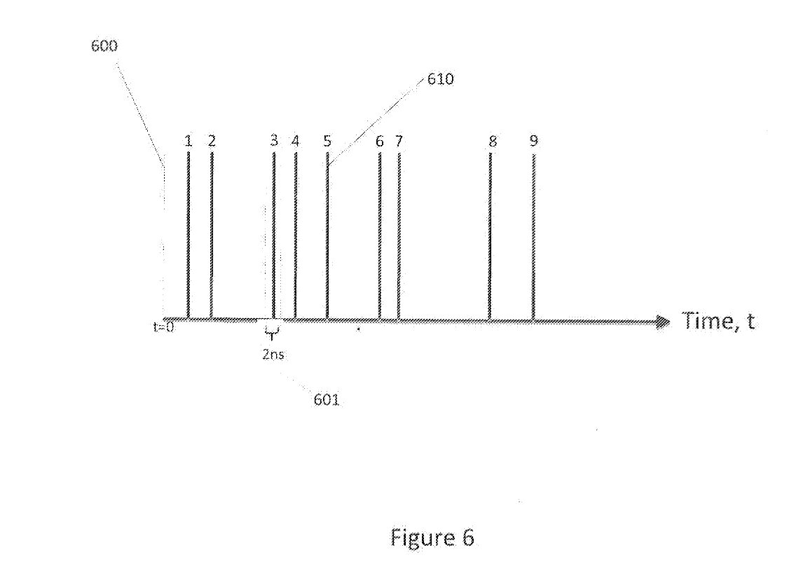

FIG. 6 is a schematic representation of a timing schedule for receiver 220 according to an embodiment. Since the receiver 220 has access to the same set of randomly generated numbers as the transmitter 120, it is able to generate the same transmission schedule, and therefore will ‘know’ when a data bit is transmitted by transmitter 120. It will therefore be appreciated that it is only necessary to switch on the detectors of the system in order to coincide with the expected time that a data bit is to be received according to the transmission schedule. This reduces the chances that spurious data (from the environment or an eavesdropper for example) is detected, since (for the majority of the time that the system is active) the detectors are in a state that prevents them from registering an incident photon.

As explained above, receiver 220 will generally proceed to take a measurement within a time window defined according to a tolerance in transmission time—the width of such a window can be predefined, or set ‘on the fly’ to take account of variations in such things as environmental conditions. In this regard, any photon detected within the window within which receiver 220 is operable to detect will be assumed to be one which has been transmitted by transmitter 120. According to an embodiment, receiver 220 comprises four detectors arranged as in FIG. 3—that is to say, the detectors according to an embodiment are conventional in the sense that they are photodetectors (such as cascade or avalanche photodiodes for example) which require no special modification to be used according to the system described with reference to FIG. 4. The detectors are operable to produce a signal (i.e. to ‘click’) when a photon is incident. However, in order to take a measurement, such a detector will normally need to be primed to a predefined cut-in voltage, below which no signal will be produced irrespective of the number of photons incident thereon. Therefore, it is possible to open predetermined reception windows for detection within which a photon can be received and thus a data bit measured. According to an embodiment, reception windows are opened at times corresponding to the irregular transmission schedule used by the transmission apparatus. Since the reception apparatus has access to the same list of random numbers from pRNG 160 as the transmitter, it can use the numbers to determine the transmission timing schedule, and ‘turn on’ the detectors at corresponding times in order to take measurements. The width of the windows during which the detectors are switched on, or active, is determined with reference to parameter d as described above. According to an embodiment, the detectors are active for the duration of a measurement window which is centred at the time that a data bit is expected according to the transmission list.

Referring to FIG. 6, a reception window 601 of width 2 ns is depicted within which reception of a data bit (here that transmitted as photon number 3) is recorded. It will be appreciated that, for the reasons mentioned above, the exact time that the data bit is recorded may not coincide with an expected time according to a perfect system, hence the requirement for a reception window, the width of which is small but finite. Similarly to FIG. 5, a base time is shown with reference to dotted line 600, whilst solid lines 610 depict the transmission times at which a data bit can be expected. It will be appreciated that the width of a detection window can vary as required in order adequately ensure that a transmitted photon is detected, and the above is not intended to be limiting.

According to an embodiment, actual transmission times (e.g. 12.07 ns after t=0) need not be used by the system. Rather, it is possible to encode specific timings using integer values for example, such that t=1 can correspond to 12.07 ns after t=0 and so forth, and represent the first photon transmitted for example.

According to an embodiment, the QKD transmission and reception apparatus include clocks 170. These clocks tick at the same rate and tick at the same time. Such synchronized clocks are made available by using GPS (global positioning system) chips for example. More specifically, both the transmitter and receiver comprise GPS receiver modules operable to receive a GPS signal (not specifically shown). It will be appreciated that a GPS signal from a GPS satellites continually transmits messages which include data representing:
i) the time the message was sent
ii) precise orbital information (ephemeris)
iii) the general system health and rough orbits of all GPS satellites (the almanac).

Therefore, amongst other payload data, a GPS signal comprises accurate timing data which can be used to synchronise a transmission and reception scheme for a system according to an embodiment.

The provision of an accurate clock signal which is shared between the transmission and reception apparatus of the system allows the transmission and reception timings between sub-systems to be synchronised—that is to say, not only can timings be synchronised, but the start point can also be synchronised in order to ensure that there is no significant ‘drift’ between the timing schedules of the transmitter and receiver. Accordingly, in order for the receiver 220 to ‘know’ when to open the detectors in order to take a measurement according to the timing schedule, there has to be a base time that both the transmission system and the reception system know beforehand—this is t=0 as described above with reference to the figures. It will be appreciated that t=0 can actually correspond to any arbitrary time—all that is required is that both transmission and reception parts of the system agree on the same arbitrary time as a starting time, or base time.

According to an embodiment, a simple handshake protocol between the transmission and reception portions of the system can be used in order to provide a reference (base) time that is used as the point from which all measurements for timings can be taken. For example, the receiving system 200 can send a message to the transmission system 100 using classical channel 60 which indicates that it is operable to begin reception of a quantum signal over quantum channel 50. Upon reception, transmission apparatus 100 can signal apparatus 100 that transmission will begin at a given time, such as 2 seconds from the time the transmission is sent for example.

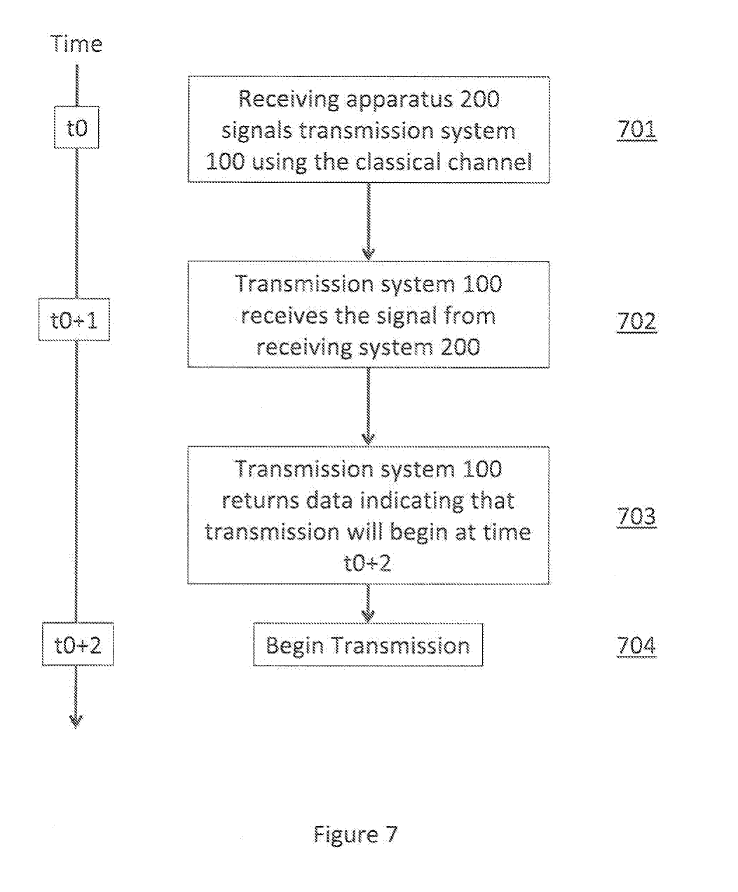

In this connection, FIG. 7 is a flow chart depicting a handshake protocol according to an embodiment. At step 701 receiving apparatus 200 signals transmission system 100 using the classical channel. The data sent at step 701 is sufficient to indicate that the receiving system 200 is prepared to accept an incoming quantum signal via receiver 220. This occurs at time to.

At step 702, corresponding to time t0+1, transmission system 100 receives the signal from receiving system 200, and returns data (step 703) at time t0+1 indicating that transmission will begin at time t0+2. No further communication under the handshake is necessary, and transmission can begin at t0+2 (step 704). The timings given above are arbitrary, and not intended to be limiting. It will be appreciated by those skilled in the art that all that is required is a basic protocol between sub-systems of the apparatus which alerts the transmission apparatus to the fact that the receiving apparatus is primed and ready to receive a signal (over the quantum channel at least), and which provides the receiving apparatus with a time at which transmission will begin so that the receiving apparatus has an initial time from which to calibrate the opening of detection windows for measurements to be taken. Accordingly, in the example given with reference to FIG. 7, time t0+2 will be the time stamp from which timings for the transmission system 100 and receiving system 200 are determined, and thus corresponds to t=0 above.

Following reception of bits at receiver 220 as described above, either with reference to a scheme in which bits are sent with irregular period, or according to a scheme in which bits are interposed with noise to form a signal which can be a signal of regular or irregular period, a random subset of measurements are destructively selected at receiving apparatus 200, such as 10% for example, and the times and the values (both data and basis) are transmitted over the classical channel to apparatus 100. The subset is compared with a reference list and an estimate of the error rate is thereby computed at the transmission apparatus—if too many of the received values that were measured in the correct basis are wrong, then the session can be aborted. For example, if it is determined that more than 5% of the values are wrong, the session can be scrapped—other alternatives are clearly feasible.

Measurement times and basis values (but not data values) for all received measurements are sent to the transmission apparatus 100 so that it can be determined which values are present and correct at receiver 200—all other measurements are disregarded. Note that no information about the data value is being transmitted by the receiver 200. This, again, offers any potential eavesdropper no help in reverse engineering the pRNG seed.

According to an embodiment, and as touched upon above, rather than transmitting real time for the measurements, the legitimate photon number can be transmitted, i.e. the 3'rd photon was transmitted at 10.07 ns, the 4'th photon was transmitted at 13.44 ns, the 5'th photon was transmitted at 17.93 ns and so on for example. The system can convert 3'rd to mean 10.07 ns, but an eavesdropper cannot. Referring to measurement 3 for example does not tell the eavesdropper when that transmission took place.

Error correction can now be performed. According to an embodiment, a Cascade-like algorithm or a randomized LDPC (low density parity check) algorithm can be used. A suitable LDPC scheme for performing error correction is described in, for example, Applicant's co-pending UK Patent Application with Publication No. 2455283, the contents of which are incorporated herein by reference in their entirety. A suitable Cascade scheme for performing error correction is described in, for example, G. Brassard and L. Salvail. Secret-key reconciliation by public discussion, Eurocrypt, pages 410-423, 1993, the contents of which are incorporated herein by reference in their entirety.

Once the error correction has been performed, privacy amplification can be performed. This is designed to eliminate any information that an eavesdropper might have gained. It is assumed that an eavesdropper cannot distinguish correct photons from the background noise, and that an eavesdropper does not know the basis used to encode the information. Note that a list of transmission intervals is generated by both the transmission and the reception apparatus.

Accordingly, during a QKD session, the transmission apparatus 100 and reception apparatus 200 end up with a shared random secret (after the error correction scheme). It is possible that an eavesdropper can determine some information about this shared secret. This might be because some photons were sent as multi-photons (which can be—and were—captured), or it might be because Cascade is used during which transmission and reception apparatus share parity information over the classical channel (which an eavesdropper can intercept). Other alternatives are possible as will be appreciated. According to an embodiment, the operational parameters of the run can be measured, and a theoretical upper limit to the amount of information that an eavesdropper could have obtained can therefore be computed. Having computed this, that number of bits from the shared secret are deleted. In order to delete information, a hash operation is performed on the shared secret by the system that reduces it in size by the amount that an eavesdropper has potentially obtained. This process is known as Privacy Amplification. Theoretically, a 2-universal hash function can be used. However, in practice and according to an embodiment, a scheme such as MGF1 (P1363 standard) is acceptable.

Although the above has been described primarily with reference to the provision of generating a shared secret using polarised photons, it will be appreciated by those skilled in the art that alternative schemes can be employed. For example, the system as described herein can easily be modified so that phase modulation can be used instead of polarisation modulation. Furthermore, it will recognised by those skilled in the art that communications between sub-systems of the apparatus can be employed in various ways, such as through free space, or using optical fibres for example—the choice will be dependent on the type of modulation required, and the nature of the system desired. The above is not therefore intended to be limiting—that is to say, it is to be understood that the above-referenced arrangements are illustrative of the application of the principles disclosed herein. It will be apparent to those of ordinary skill in the art that numerous modifications can be made without departing from the principles and concepts of this disclosure, as set forth in the claims below.

1. A QKD transmission method comprising:
generating a transmission list for a plurality of data bits, the list comprising an irregular timing schedule defining respective times for transmission of the data bits;
providing a clock signal; and
using the clock signal to initiate the transmission of the data bits at a predetermined time in order to provide a QKD signal.

2. A QKD transmission method as claimed in claim 1, further comprising using the transmission list to generate a timing schedule for detection of respective ones of the data bits of the signal.

3. A QKD transmission method as claimed 1, wherein the clock signal is provided using a global positioning system (GPS) signal.

4. A QKD transmission method as claimed in claim 1, wherein the transmission list further comprises a timing schedule for bits representing noise for the signal.

5. A QKD transmission method as claimed in claim 2, wherein the detection of data bits comprises:
defining a set of detection windows of predefined duration using the timing schedule for detection of respective ones of the data bits.

6. A QKD transmission method as claimed in claim 1, wherein the QKD signal has a regular period.

7. A QKD transmission method as claimed in claim 1, where the QKD signal has an irregular period.

8. A QKD transmission method as claimed in claim 6, wherein transmission slots of the signal between data bits comprise noise bits.

9. A QKD transmission method as claimed in claim 7, wherein the disposition of both noise and data bits within the signal is irregular.

10. A QKD transmission method as claimed in claim 1, wherein the timing schedule is generated using a number sequence derived from a pseudo random number generator.

11. A QKD transmission apparatus comprising a processor and a pseudo random number generator (pRNG), the processor operable to use a random number sequence from the pRNG in order to generate a QKD signal for transmission wherein the disposition of data bits within the signal is irregular.

12. A QKD transmission apparatus as claimed in claim 11, wherein the processor is further operable to augment the generated signal with random bits representing noise.

13. A QKD transmission apparatus as claimed in claim 11, further comprising a clock module suitable for receiving an external clock signal, wherein the apparatus is operable to use the clock signal in order to transmit the signal.

14. (canceled)

15. (canceled)

16. A method for generating shared secret data in a QKD system comprising transmitting data bits at irregular intervals in a quantum signal.

17. A method as claimed in claim 16, wherein the quantum signal has a regular period and wherein portions of the signal not comprising data bits comprise bits representing random noise.

18. A method as claimed in claim 16, wherein the quantum signal has an irregular period and wherein portions of the signal not comprising data bits comprise bits representing random noise.

19. A method as claimed in claim 16, wherein the irregular intervals are derived using a number sequence generated using a pseudo random number generator.

20. A method as claimed in claim 16, further comprising deriving a clock signal for the system using an external clock source, the clock signal used to synchronize a reception of the signal with the transmission.
